(19) United States
(12) Patent Application Publication
(10) Pub. No.: US 2008/0011494 A1
(43) Pub. Date: Jan. 17, 2008

(54) Grooming Apparatus for Artificial Racetrack Surface

(75) Inventor: Martin Collins, Tarlton (GB)

Correspondence Address: STOLL KEENON OGDEN, PLLC, 2000 PNC PLAZA, 500 WEST JEFFERSON STREET, LOUISVILLE, KY, 40202, US

(73) Assignee: Martin Collins International, LTD, Hungerford (GB)

(21) Appl. No.: 11/776,712

(22) Filed: Jul. 12, 2007

Related U.S. Application Data
(60) Provisional application No. 60/830,776, filed on Jul. 14, 2006.

(51) Int. Cl. A01B 15/00; A01B 35/24; E01C 19/23

(52) U.S. Cl. 172/96; 172/349; 404/122

(57) ABSTRACT

An apparatus for grooming surfaces includes a generally horizontally oriented skeletal primary frame; an ground support assembly for supporting the apparatus for movement over a surface; a tine support assembly movably mounted to the primary frame; an array of tines mounted to the tine support assembly and projecting generally downwardly a predetermined distance there from; and an apparatus for imparting controlled substantially vertical motion to the tines for adjusting a depth of surface penetration by the array of tines.

This application benefits from and claims priority to U.S. provisional patent application Ser. No. 60/830,776 filed Jul. 14, 2006 entitled “Grooming Apparatus For Artificial Racetrack Surface.”

### BRIEF DESCRIPTION OF THE DRAWINGS

FIG. 1 is perspective view of a grooming apparatus for artificial race track surface according to multiple embodiments and alternatives;

FIG. 2 is a front view of the apparatus illustrated in FIG. 1;

FIG. 3 is a right-side view of the apparatus illustrated in FIG. 1;

FIG. 4 is a rear view of the apparatus illustrated in FIG. 1;

FIG. 5 is a left-side view of the apparatus illustrated in FIG. 1;

FIG. 6 is a top view of the index arrangement for gauging depth;

FIG. 7 is a partial side view of the tine mover assembly; and

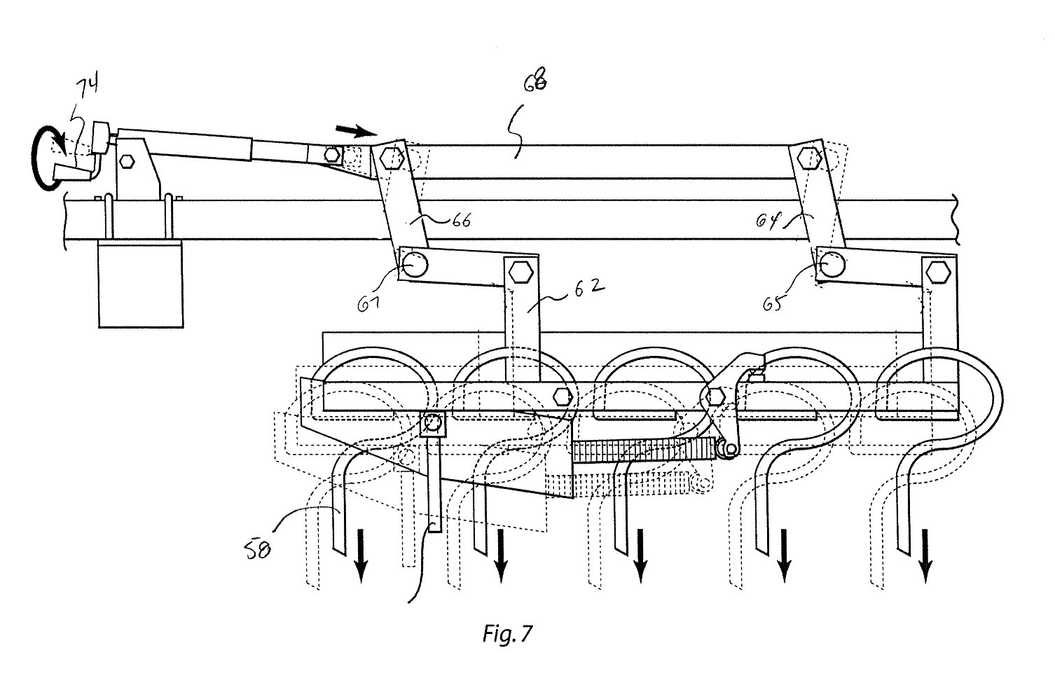

FIG. 8 is a perspective right-side view of the shield and spike arrangement according to multiple embodiments and alternatives.

### MULTIPLE EMBODIMENTS AND ALTERNATIVES

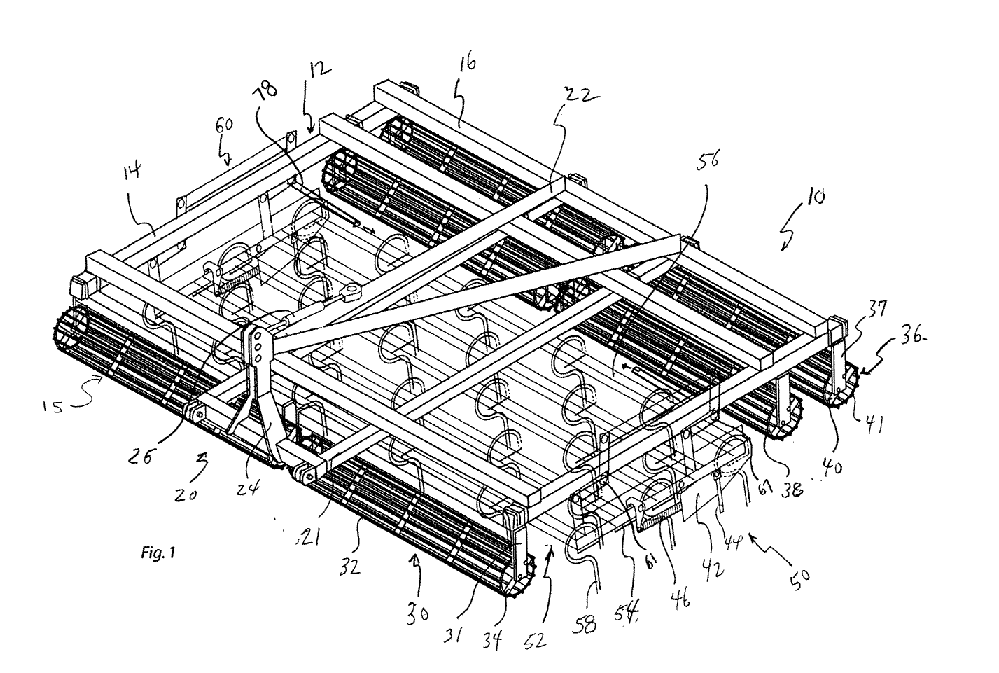

Referring in general to FIG. 1, an apparatus 10 for grooming surfaces, such as, for example sports surfaces or, more particularly, artificial horse race tracks includes a generally horizontally oriented skeletal primary frame 12 which is formed from longitudinally extending support members 14 and transversally extending support members 16 which form a generally square frame structure. Also included is a ground support assembly 15 for supporting the apparatus 10 in movement over a track surface, a tine support assembly 50 movably mounted to the primary frame 12, an array of tines 58 mounted to the tine support assembly 50 and projecting generally downwardly a selected distance there from, and an apparatus, such as, for example, a tine mover assembly 60 for imparting controlled substantially vertical motion to the tines 58 for adjusting a depth of surface penetration by the array of tines 58.

A towing assembly 20 is provided in multiple embodiments in order to attach a means for towing the apparatus. The apparatus 10 for grooming artificial race tracks according to the present embodiments may be towed behind and attached to a tractor or other vehicle by means for towing such as, for example, a towing assembly 20 selected from, but not limited to, the group three-point farm hitch and single-point receiver hitch. Illustrated in the Figs. is structural means to attach the apparatus to a three-point hitch as commonly found on a tractor. Alternative embodiments are provided which utilize means to attach the apparatus to a single-point receiver hitch as commonly found on a pickup truck or other vehicle.

Referring to FIGS. 1 through 5, the towing assembly 20 includes two spaced longitudinally oriented support members 21. An upstanding yoke 24 is mounted intermediate the longitudinal support members 21 at one end of the apparatus 10 defining the forward most end with respect to intended motion and the end that is connected to a tractor (not shown) for towing. The upstanding yoke 24 is connected to an angled yoke 22 that extends the full longitudinal length of the apparatus 10 and is connected to the rearmost traverse support member 16. A connector rod 26 is pivotally mounted to the upstanding yoke 24 at the uppermost point thereof for attachment to a tow vehicle, such as, for example, a tractor, for towing the apparatus 10.

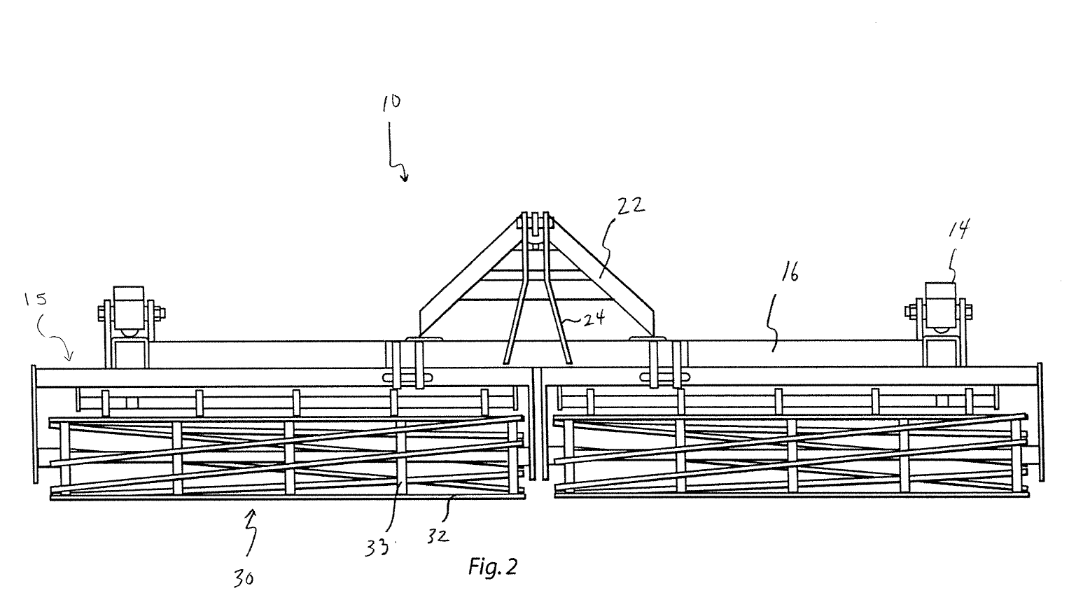

Embodiments provide for a ground support assembly 15 for moving the apparatus 10 across a race track surface and include a plurality of cage rollers 30,36. Embodiments include forward mounted cage rollers 30. The forward mounted cage rollers 30 are affixed to downwardly projecting support bars 31 extending from the longitudinal support member 14. As shown in FIG. 2, each one of the pair of forward cage rollers 30 is formed from a series of generally horizontally oriented rods 32 extending between a plurality hoop members 33 that are mounted to a central axle using spokes 34. The transverse rods 32 of the forward cage rollers 30 include helically oriented rods 32 which act to churn the artificial surface as they roll there across.

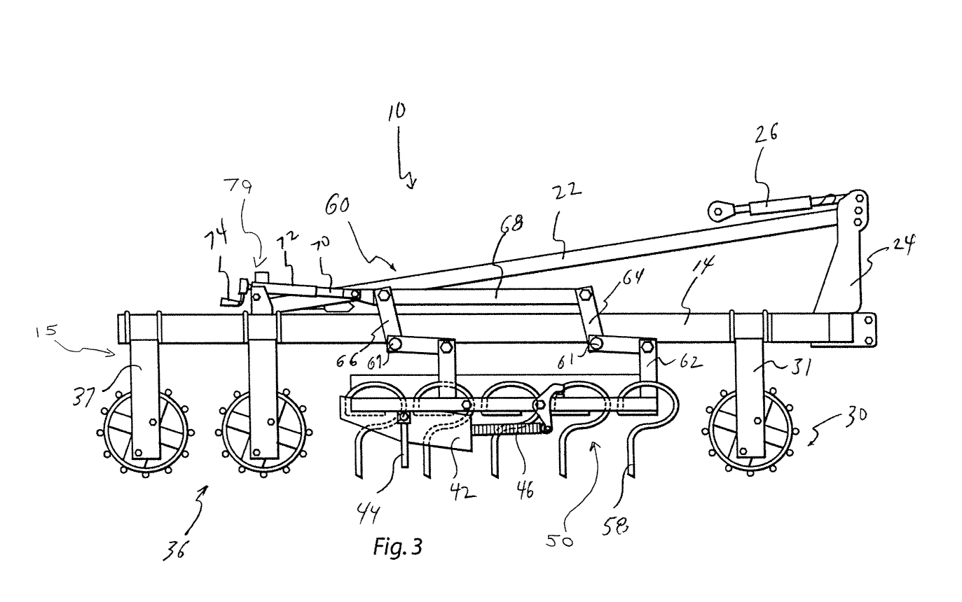

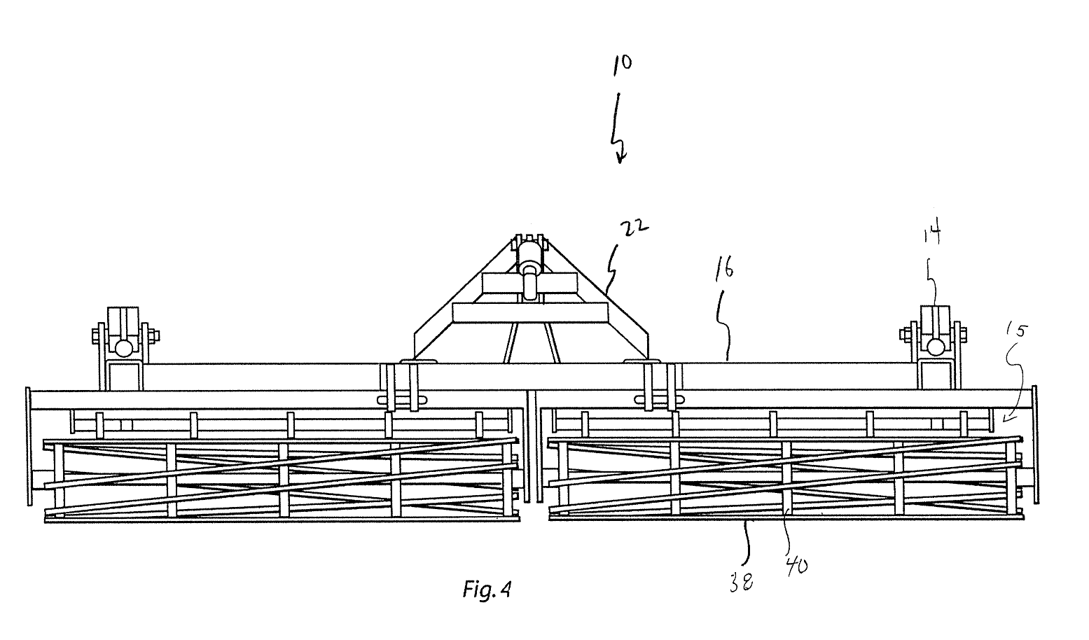

As shown in FIGS. 1 and 3, four pair of rear cage rollers 36 are mounted to the primary frame 12 at the rear portion of the longitudinal support members 14 using downwardly projecting bars 37. As shown in FIG. 4, the rearmost sets of cage rollers 36 include linear rods 38 extending between the hoop and spoke assembly 40, 41. Accordingly, embodiments provide that the primary frame 12 may be towed across a race track surface being supported by six cage rollers 30, 36.

An important aspect of the present embodiments is the ability of the grooming apparatus 10 to selectably adjust to various artificial tracks, as the desired depth of grooming will vary based on the draining system and thickness of the track material itself. Accordingly, it will be seen that the primary track grooming tines may be adjusted as desired for depth.

Referring back to FIGS. 1, 3 and 5, the tine support assembly 50 is formed from a series of longitudinally oriented support members 54 which are joined together by a series of transversely extended support members 52. The tine support assembly 50 is adjustably mounted to the apparatus 10 intermediate the forward and the rearmost rollers 36.

A plurality of downwardly projecting tines 58 are each formed as desired, and in some embodiments, generally in the shape of a question mark and are mounted to the transversely extending support members 56 in a selectably predetermined array. The tines 58 are arranged in horizontally extending rows in diagonal alignment across the rows in the tine support assembly 50.

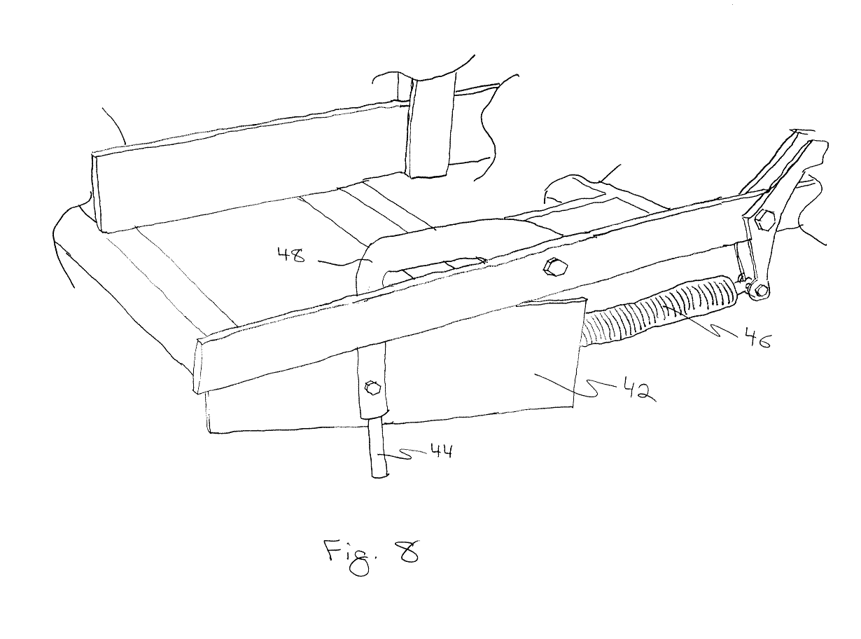

It will be seen that several aspects of the present embodiments mirror one another from one side of the apparatus 10 to the other. Such is the case with a shield 42. As FIGS. 1 and 8 illustrate, the shield 42 is adjustably mounted to the support members 52, outboard of the array of tines 58, and biased there against with biasing means such as, for example, a spring 46. A downwardly projecting metallic spike 44 is adjustably secured to a tubular receiver 48 which is pivotally mounted to the tine support sub-frame 52 adjacent and outboard of the shield 42.

The tines 58 move in a substantially vertical path in order to selectably adjust the depth of penetration of the tines into the artificial track such that the track is sufficiently groomed without the tines penetrating so deep as to damage the underlying, and deeper, drainage system typically found underneath the track surface. To that end, a tine mover assembly 60 is provided and shown in FIGS. 1, 3 and 5. As seen in FIG. 1, the tine mover assembly 60 is duplicated on either side of the apparatus 10. Provision of inner connection rods 78 ensures that the mechanisms are connected to one another and that operation of one tine mover assembly 60 serves to also operate the other thereby lifting or lowering both sides of the tine support assembly 50 simultaneously.

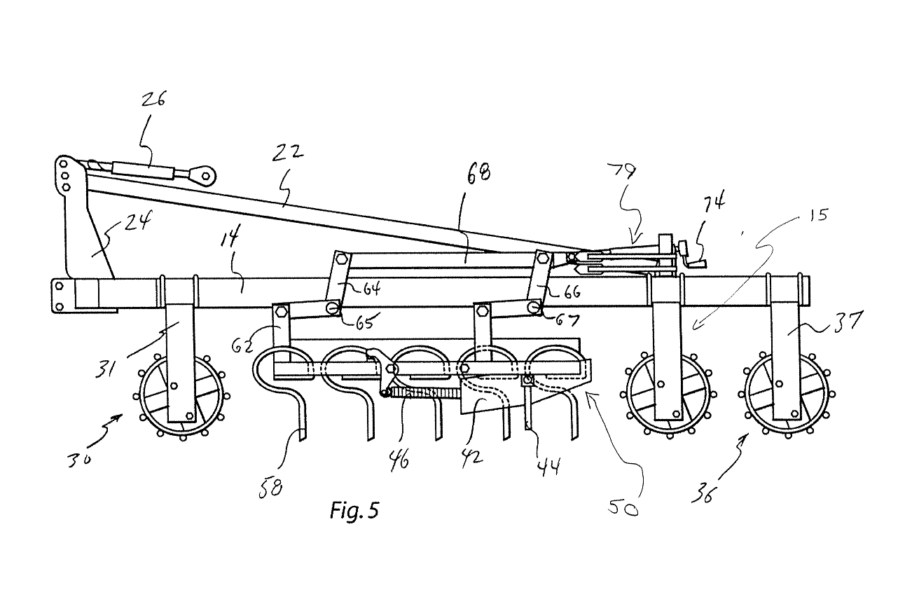

Turning now to FIG. 3, the tine mover assembly 60 is illustrated on one side of the track grooming apparatus 10. The tine mover assembly 60 includes mechanical linkage, such as, for example, a pair of spaced bell cranks 64, 66 which are pivotally mounted to a respective longitudinal support member 14 at respective pivots 61, 62. A longitudinal bar 68 extends between the bell cranks 64, 66 at a position above the longitudinal support member 14. The other end of each of the bell cranks 64, 66 is connected by means of a transverse bar 61A to a vertically projecting connector 62 extending from the tine support rack 50 to the lowermost arm of each bell crank 64, 66. As is known, bell cranks are used to convert horizontal motion to vertical motion. As seen in FIG. 3 and 5, the connecting member 68 experiences horizontal movement which is translated to vertical movement of the tine support sub-assembly 52 by the bell cranks 64, 66. In order to control vertical movement, a tine depth control assembly 79, in the form of a piston and cylinder serving in general as a two-force member, is pivotally connected at both ends: at one end to the longitudinally oriented connector member 68 and at the other end, to the primary frame 12. Referring to FIG. 3, the tine depth control assembly 79 includes a receiver 72 that telescopically receives an indexing member 70 extending between the connector member 68 and the receiver 72. A crank 74 is provided on the distal end of the receiver 72. Internally, and hidden from view in the figures, the crank 74 is connected to a threaded rod which is threadedly received by the indexing member 70 inwardly or outwardly of the receiver 72 thereby inducing linear movement of the receiver 72 upon rotation of the crank 74, the receiver 72 being in operational engagement with the mechanical linkage for movement of the linkage upon movement of the receiver 72.

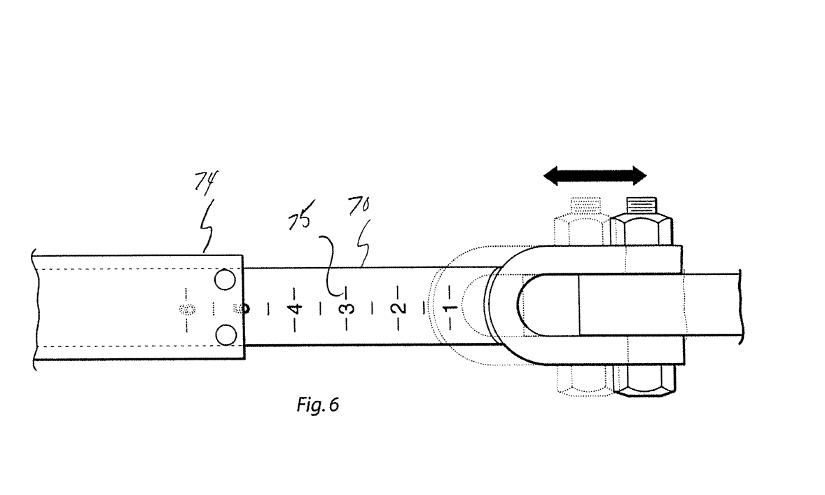

As seen in FIG. 6, an index arrangement operatively associated with the receiver is provided wherein index marks 75 are provided on the indexing member 70. At the location where the index member 70 enters the receiver 74, an indication of the relative depth of the tines is provided by reference to the index marks 75.

In operation, the desired depth of grooming penetration with respect to the index marks 75 is selected and one or both of the hand cranks 74 is turned. In so turning, the internal screw either draws or drives the index member 70 in or out of the receiver 72. This causes linear movement of the connecting member 68 driving both bell cranks 64, 66 (on each side of the apparatus 10) about the respective pivot points 61, 67 and the inner connection rods 78 (refer once more to FIG. 1) translate the driven movement of one end of the tine support sub-assembly 52 to the other end, thereby causing movement of each lifting mechanism and accordingly, the entire tine support assembly. Once the depth of penetration is determined and set using the index markers 72, the apparatus 10 may be guided across a race track surface. The front rollers 30 churn the track surface and the following tines 58 plow through the remaining track surface. Finally, the rear rollers 36 act to smooth the surface.

It will therefore be readily understood by those persons skilled in the art that the present embodiments are susceptible of a broad utility and application. While described in all currently foreseeable embodiments, there may be other, unforeseeable embodiments and adaptations, as well as variations, modifications and equivalent arrangements that do not depart from the substance or scope of the present embodiments. The foregoing disclosure is not intended or to be construed to limit the present embodiments or alternatives, or otherwise to exclude such other embodiments, alternatives, adaptations, variations, modifications and equivalent arrangements, the present embodiments being limited only by the claims appended hereto and the equivalents thereof.

I claim:

1. An apparatus for grooming surfaces comprising:
a generally horizontally oriented skeletal primary frame;
a ground support assembly for supporting said apparatus in movement over a surface;
a tine support assembly movably mounted to said primary frame;
an array of tines mounted to said tine support assembly and projecting generally downwardly a selected distance there from; and
an apparatus for imparting controlled substantially vertical motion to said tines for adjusting a depth of surface penetration by said array of tines.

2. An apparatus for grooming surfaces according to claim 1 and further comprising a tine mover assembly for controlling movement of said tine support assembly.

3. An apparatus for grooming surfaces according to claim 2 including a tine depth control assembly having a manually operated tine mover assembly including mechanical linkage connected to said tine mover and said tine support assembly, said linkage converting movement of said tine mover to substantially vertical tine movement.

4. An apparatus for grooming surfaces according to claim 3 wherein said tine mover assembly includes a manually operated crank engaged with said mechanical linkage for operator initiated movements of said tines.

5. An apparatus for grooming surfaces according to claim 4 wherein said tine mover assembly includes an assembly for converting rotational movement of said crank into operation movement of said linkage.

6. An apparatus for grooming surfaces according to claim 4 and further comprising said crank attached to a threaded rod and a receiver threadedly engaged with said crank, inducing linear movement of said receiver upon rotation of said crank, said receiver being in operational engagement with said mechanical linkage for movement of said linkage upon movement of said receiver.

7. An apparatus for grooming surfaces according to claim 4 and further comprising an index arrangement operatively associated with said receiver for determining tine depth.

8. An apparatus for grooming surfaces according to claim 1 and further comprising a shield adjustably mounted to support members of said tine support assembly outboard of said tine array.

9. An apparatus for grooming surfaces according to claim 7 wherein said shield is biased away from said tine array using biasing means.

10. An apparatus for grooming surfaces according to claim 9 wherein said biasing means is a spring.

11. An apparatus for grooming surfaces according to claim 1 wherein said ground support assembly includes a plurality of cage rollers.

12. An apparatus for grooming surfaces according to claim 11 wherein said cage rollers include a plurality of generally horizontally oriented rods extending between a plurality of hoop members.

13. An apparatus for grooming surfaces according to claim 12 wherein at least a portion of said rods are helically oriented.

14. An apparatus for grooming surfaces according to claim 1 wherein said tines are arranged in horizontally extending rows in diagonal alignment across said rows.

15. An apparatus for grooming surfaces comprising:
a generally horizontally oriented skeletal primary frame;
a means for towing;
a ground support assembly for supporting said apparatus in movement over a surface;
a tine support assembly movably mounted to said primary frame;
an array of tines mounted to said tine support assembly and projecting generally downwardly an adjustably selected distance there from;
an apparatus for imparting controlled substantially vertical motion to said tines for adjusting a depth of surface penetration by said array of tines; and
a tine mover assembly for controlling movements of said tine support assembly, said tine mover assembly including a manually operated tine depth control assembly and mechanical linkage connected to said tine depth control assembly and said tine support assembly, said mechanical linkage converting movement of said tine mover assembly to substantially vertical tine movement, wherein said tine depth control assembly includes a manually operated crank engaged with said mechanical linkage for operator initiated movement of said tines.

16. An apparatus for grooming surfaces according to claim 15 wherein said crank of tine control assembly converts rotational movement of said crank into operational movement of said linkage.

17. An apparatus for grooming surfaces according to claim 15 and further comprising a threaded rod attached to said crank and a receiver threadedly engaged with said crank, inducing linear movement of said receiver upon rotation of said crank, said receiver being in operation engagement with said linkage for movement of said linkage upon movements of said receiver.

18. An apparatus for grooming surfaces according to claim 17 and further comprising an index arrangement operatively associated with said receiver for determining tine depth.

19. An apparatus for grooming surfaces according to claim 15 and further comprising a shield mounted to said tine rack outboard of said tine array.

20. An apparatus for grooming surfaces according to claim 15 and further comprising said means for towing selected from the group including three-point farm hitch and single-point receiver hitch.

21. An apparatus for grooming surfaces according to claim 17 wherein said shield is biased away from said tine array using biasing means.

22. An apparatus for grooming surfaces comprising:
a generally horizontally oriented skeletal primary frame;
a ground support assembly for supporting said apparatus in movement over a surface;
a tine support assembly movably mounted to said primary frame;
an array of tines mounted to said tine support assembly and projecting generally downwardly an adjustably selected distance there from;
an apparatus for imparting controlled substantially vertical motion to said tines for adjusting a depth of surface penetration by said array of tines; and
a shield mounted to said tine rack outboard of said tine array.
